(19) United States
(12) Patent Application Publication
(10) Pub. No.: US 2006/0203431 A1
(43) Pub. Date: Sep. 14, 2006

(54) Plasma display panel (PDP) driving apparatus

(75) Inventor: Jin-Boo Son, Suwon-si (KR)

Correspondence Address: LEE & MORSE, P.C., SUITE 2000, 1101 WILSON BOULEVARD, ARLINGTON, VA, 22209, US

(73) Assignee: Samsung SDI Co., Ltd.

(21) Appl. No.: 11/363,285

(22) Filed: Feb. 28, 2006

(30) Foreign Application Priority Data
Feb. 28, 2005 (KR) 10-2005-0016359

(51) Int. Cl. H02B 1/00

(52) U.S. Cl. 361/600

(57) ABSTRACT

A driving apparatus for a PDP may employ different connection schemes that may include different elements to stably charge capacitors respectively connected to each switching device with the externally applied voltage when the PDP is initially turned on. The capacitors associated with switching devices that have source terminals connected to a voltage source that supplies a ground voltage or lower may be stably charged directly via the externally applied voltage source. A ramping capacitor or a ramping resistor may be connected to the switching devices that have a drain terminal connected to a switching device that does not have a source terminal connected to a voltage source that supplies a ground voltage or lower to output a ramping signal to indirectly and stably charge the capacitors associated with such switching devices from the external voltage source.

### BACKGROUND OF THE INVENTION

1. Field of the Invention

The invention relates to a driving apparatus of a plasma display panel (PDP). More particularly, the invention relates to a driving apparatus of a PDP, in which an operating voltage for operating a driving IC and a switching device is stably charged in a capacitor when the PDP is initially powered on.

2. Description of the Related Art

Plasma display panels (PDPs) are flat display panels that form images using gas plasma discharge phenomena. Electrical signals excite discharge gases causing ultraviolet (UV) light to be emitted. The UV light excites phosphor materials to produce the red, green, and blue primary colors and to thereby form an image on the PDP.

PDPs include a first substrate and a second substrate, which face each other and have a predetermined space between them. A plasma forming discharge gas is filled between the first substrate and the second substrate and a plurality of electrodes are arranged on the first substrate and the second substrate. Barrier ribs define a plurality of discharge cells in the space between the first substrate and the second substrate. An MgO dielectric layer is arranged between the first substrate and the second substrate. Phosphor material is provided in each discharge cell and the color (e.g., red, blue, or green) of the phosphor material determines the color that the discharge cell can emit. The phosphor materials are generally arranged in a predetermined pattern between the first substrate and the second substrate such that each pixel of an image to be displayed generally includes a discharge cell for the color red, a discharge cell for the color blue and a discharge cell for the color green. When a discharge voltage is applied to the electrodes, the plasma forming discharge gas is energized giving rise to plasma and UV light. The emitted UV light excites the phosphors arranged in a predetermined pattern, thereby displaying a desired image on the PDP.

The driving apparatus of the PDP includes a plurality of voltage sources for applying driving signals to a plurality of electrodes, a plurality of switching devices, and a plurality of driving ICs for controlling the switching operation of the switching devices. The driving signals are output from the driving apparatus of the PDP to the respective electrodes by the switching operation of the switching devices.

When a PDP with such a driving apparatus is initially powered on, an operating voltage Vcc is supplied to the driving ICs that control the switching operation of the switching devices. The operating voltage Vcc is supplied from an external source, for example, from a power supply, and operates the driving ICs and the switching devices. The operating voltage Vcc is charged in advance in a capacitor connected between the source terminal of each switching device and each driving IC in the PDP driving apparatus to help enable stable switching operations. However, to stably charge the operating voltage Vcc in the capacitor connected between the source terminal of each switching device and the driving IC, a voltage that is lower than a ground voltage must be applied to the source terminal of the each switching device. Thus, when the source terminal of the switching device is connected to a voltage source that outputs a voltage that is lower than the ground voltage, the operating voltage Vcc applied from an external source can be stably charged in the capacitor. However, when the source terminal of the switching device is not connected to a voltage source that outputs a voltage that is lower than the ground voltage and the voltage of the source terminal is unstable, the operating voltage Vcc is not stably charged in the capacitor. Also, for example, when the voltage of the source terminal of a switching device becomes lower than the ground voltage due to the switching operation of other switching devices, a surge current is generated and other circuit devices may be damaged as a result of the abrupt application of the ground voltage.

### SUMMARY OF THE INVENTION

The invention is therefore directed to a driving apparatus for a plasma display panel, which substantially overcomes one or more of the problems due to the limitations and disadvantages of the related art.

It is therefore a feature of exemplary embodiments of the invention to provide a driving apparatus of a PDP, in which an operating voltage for operating a driving IC and a switching device is stably charged in a capacitor when the PDP is initially powered on.

At least one of the above and other features and advantages of the invention may be realized by providing a driving apparatus of a plasma display panel (PDP) that includes a plurality of voltage sources, a plurality of switching devices that consist of a first group of switching devices and a second group of switching devices, and a plurality of driving ICs for controlling a switching operation of a respective one of the plurality of switching devices to output a driving signal from the respective one of the plurality of driving ICs. In such a driving apparatus, a capacitor may be connected between each of the plurality of driving ICs and a source terminal of the respective one of the plurality of switching devices, and each driving IC may receive an operating voltage Vcc from an external source and outputs a control signal to a gate terminal of the respective one of the plurality of switching devices. The first group of switching devices may include the switching devices of the plurality of switching devices that have a source terminal connected to one of the plurality of voltage sources that outputs one of a ground voltage and a voltage less than ground voltage, and the second group may include remaining ones of the plurality of switching devices. When the PDP is initially powered on, the operating voltage Vcc is directly charged in the capacitors that are respectively connected to the plurality of switching devices of the first group, and when a predetermined switching device of the switching devices belonging to the first group is gradually turned on, the operating voltage Vcc may be charged in the capacitors connected to respective ones of the switching devices of the second group.

In embodiments, the predetermined switching device may output a ramping signal when it is turned on. A ramping capacitor may be connected between a gate terminal and a drain terminal of the predetermined switching device. A ramping resistor may be connected to a source terminal of the predetermined switching device. The second group may include a switching device that has a source terminal that is connected to a drain terminal of the predetermined switching device.

The source terminals of the switching devices of the second group may be connected to a drain terminal of a switching device connected to the predetermined switching device, and the switching device connected to the predetermined switching device is thereby turned on, so that the operating voltage Vcc may be charged in the capacitor connected to each of the switching devices of the second group.

At least one of the above and other features and advantages of the invention may be realized by providing a driving apparatus of a plasma display panel (PDP) that may include a plurality of voltage sources, a plurality of driving circuits that receive an operating voltage from an external source, a plurality of switching devices including a first group of switching devices and a second group of switching devices, a capacitor connected to each of the plurality of switching devices, one terminal of each capacitor being connected to a source terminal of the respective switching device, and at least one of a ramping capacitor and a ramping resistor connected to the switching devices of the first group to output a ramping signal from the switching devices of the first group. The first group of switching devices may include the switching devices of the plurality of switching devices that have a source terminal that is directly connected to one of the plurality of voltage sources that outputs one of a ground voltage and a voltage less than ground voltage. The second group may include any remaining ones of the plurality of switching devices.

The driving apparatus may include a plurality of ramping resistors, each connected to a respective one of the switching devices of the first group. The ramping resistor may have a terminal connected to the source terminal of the respective one of the plurality of switching devices of the first group, and another terminal connected to a terminal of the respective capacitor. The driving apparatus may include a plurality of ramping capacitors, each connected to a respective one of the switching devices of the first group.

The second group of switching devices may include a first sub-group and a second sub-group, the first sub-group including at least of the switching devices of the plurality of switching devices that has a source terminal connected to a drain terminal of at least one of the switching devices of the first group, and the second sub-group including any remaining ones of the plurality of switching devices. At least one of a ramping capacitor and a ramping resistor may be connected to the switching devices of the first sub-group to output a ramping signal from the switching devices of the first sub-group.

The driving apparatus may include a plurality of ramping resistors, each connected to a respective one of the switching devices of the first sub-group. The ramping resistors may have a terminal connected to the source terminal of the respective one of the plurality of switching devices of the first sub-group, and another terminal connected to a terminal of the respective capacitor. The driving apparatus may include a plurality of ramping capacitors, each connected to a respective one of the switching devices of the first sub-group. The ramping capacitors may have a first terminal connected to a drain of the respective switching device of the first group and a second terminal connected to a gate of the respective switching device of the first sub-group.

The first sub-group may include switching devices of the plurality of switching devices that has a source terminal connected to a drain terminal of at least one of the switching devices of the first group and a drain terminal connected to a source terminal of at least one of the switching devices of the second sub-group. Each of the switching devices of the second sub-group may have a source terminal that is connected to at least one of the switching devices of the first sub-group.

At least one of the above and other features and advantages of the invention may be realized by providing a driving apparatus of a plasma display panel (PDP) that includes a plurality of voltage sources, a plurality of driving circuits that receive an operating voltage from an external source, a plurality of switching devices that may include a first group of switching devices and a second group of switching devices, a capacitor connected to each of the plurality of switching devices, one terminal of each capacitor being connected to a source terminal of the respective switching device, and ramping signal producer that outputs a ramping signal from the switching devices of the first group. The first group of switching devices may include the switching devices of the plurality of switching devices that have a source terminal that is directly connected to one of the plurality of voltage sources that outputs one of a ground voltage and a voltage less than ground voltage. The second group of switching devices may include any remaining one of the plurality of switching devices.

The second group of switching devices may include a first sub-group and a second sub-group, the first sub-group may include at least of the switching devices of the plurality of switching devices that has a source terminal connected to a drain terminal of at least one of the switching devices of the first group, and the second sub-group may include any remaining ones of the plurality of switching devices. A ramping signal producer may be provided with the first sub-group of switching devices to output a ramping signal from the switching devices of the first sub-group.

### BRIEF DESCRIPTION OF THE DRAWINGS

The above and other features and advantages of the invention will become more apparent to those of ordinary skill in the art by describing in detail exemplary embodiments thereof with reference to the attached drawings in which:

FIG. 1 illustrates a view of an example of a plasma display panel (PDP) that may be driven by a PDP driving apparatus according to an exemplary embodiment of the invention;

FIG. 2 illustrates a view showing an exemplary electrode arrangement of the PDP shown in FIG. 1;

FIG. 3 illustrates an exemplary block diagram of a PDP driving apparatus for driving the PDP shown in FIG. 1;

FIG. 4 illustrates a timing diagram of driving signals output from respective drivers of the PDP driving apparatus shown in FIG. 3;

FIG. 5 illustrates a circuit diagram of an exemplary X-electrode driver of a PDP driving apparatus employing one or more aspects of the invention;

FIG. 6 illustrates a circuit diagram of an exemplary Y-driver of a PDP driving apparatus employing one or more aspects of the invention;

FIG. 7 illustrates a circuit diagram of an exemplary connection scheme for a switching device, a driving IC, and a capacitor of a PDP driving apparatus employing one or more aspects of the invention;

FIG. 8 illustrates a circuit diagram of an exemplary connection scheme for a switching device belonging to a first group of switching devices in a PDP driving apparatus employing one or more aspects of the invention; and

FIG. 9 illustrates a circuit diagram of another exemplary connection scheme for a switching device belonging to a first group of switching devices in a PDP driving apparatus employing one or more aspects of the invention.

### DETAILED DESCRIPTION OF THE INVENTION

Korean Patent Application No. 10-2005-0016359, filed on Feb. 28, 2005, in the Korean Intellectual Property Office, and entitled “Apparatus of driving plasma display panel,” is incorporated by reference herein in its entirety.

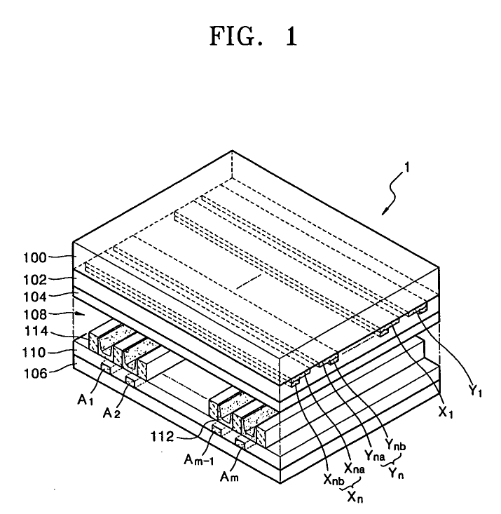

The invention will now be described more fully with reference to the accompanying drawings, in which exemplary embodiments of the invention are shown. FIG. 1 illustrates an example of a plasma display panel (PDP) that may be driven by a PDP driving apparatus according to an exemplary embodiment of the invention.

The PDP shown in FIG. 1 includes address electrodes A1 through Am, a first dielectric layer 102, a second dielectric layer 110, scan and sustain electrodes Y1 through Yn, sustain electrodes X1 through Xn, phosphor layers 112, barrier ribs 114, and a MgO protection layer 104 between a first substrate 100 and a second substrate 106.

The address electrodes A1 through Am may be formed in a predetermined pattern on a surface of the second substrate 106 that faces the first substrate 100. The second dielectric layer 110 may cover the address electrodes A1 through Am. The barrier ribs 114 may be formed parallel to the address electrodes A1 through Am on the second dielectric layer 110. The barrier ribs 114 partition discharge areas of the discharge cells from each other and help reduce optical interference between the respective discharge cells. The phosphor layers 112 may be formed between the barrier ribs 114 on the second dielectric layer 110 over the address electrodes A1 through Am. The phosphor layers 112 may include a red-emitting phosphor layer, a green-emitting phosphor layer, and a blue-emitting phosphor layer that are sequentially disposed.

The sustain electrodes X1 through Xn and scan and sustain electrodes Y1 through Yn may be formed in a predetermined pattern on a surface of the first substrate 100 that faces the second substrate 106. The sustain electrodes X1 through Xn may be arranged perpendicular to the address electrodes A1 through Am. Each intersection (i.e., overlapping region) of the sustain electrodes X1 through Xn and the scan and sustain electrodes Y1 through with the address electrodes A1 through Am corresponds to a discharge cell. Each of the sustain electrodes X1 through Xn may be composed of a transparent electrode Xna made of transparent conductive material, such as ITO (Indium Tin Oxide), and a metal electrode Xnb that helps increase conductivity. Each of the scan and sustain electrodes Y1 through Yn may be composed of a transparent electrode Yna made of transparent conductive material, such as ITO (Indium Tin Oxide), and a metal electrode Ynb that helps increase conductivity. The first dielectric layer 102 may cover the sustain electrodes X1 through Xn and scan and sustain electrodes Y1 through Yn. A protection layer 104 such as an MgO layer may cover the first dielectric layer 102 to help protect the PDP from a strong field or ion collisions. A plasma forming gas may be filled in the discharge space 108.

A PDP driving apparatus employing one or more aspects of the invention may be used to drive many different PDPs and is in no way limited to driving the PDP shown in FIG. 1. For example, a PDP driving apparatus employing one or more aspects of the invention may be used to drive a two-electrode PDP, which is different from the three-electrode PDP shown in FIG. 1. Thus, although in the following description of exemplary embodiments of a PDP driving apparatus reference may be made to the PDP illustrated in FIG. 1, a PDP driving apparatus employing one or more aspects of the invention may be employed with other types of PDPs.

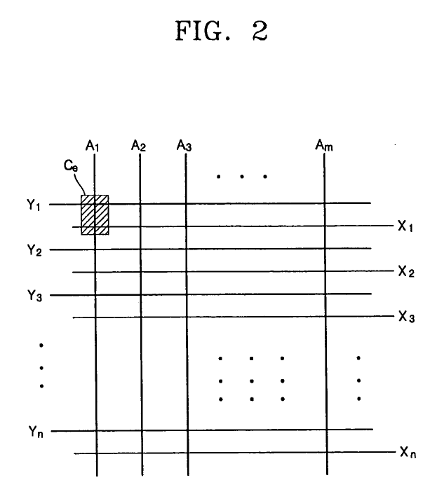

FIG. 2 illustrates a an exemplary arrangement of the electrodes of the PDP shown in FIG. 1.

As shown in FIG. 2, the scan and sustain electrodes Y1 through Yn and sustain electrodes X1 through Xn may be arranged parallel to each other and the address electrodes A1 through Am may be perpendicularly arranged to overlap and cross the scan and sustain electrodes Y1 through Yn and sustain electrodes X1 through Xn. Each intersection forms a discharge cell Ce.

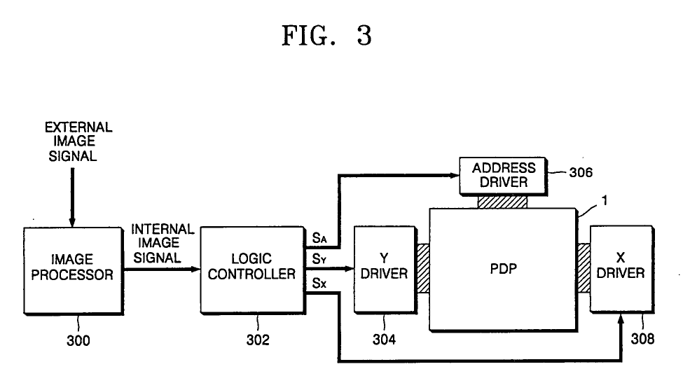

FIG. 3 illustrates a block diagram of an exemplary PDP driving apparatus for driving the PDP 1 shown in FIG. 1.

As shown in FIG. 3, the PDP driving apparatus may include an image processor 300, a logic controller 302, a Y-driver 304, an address driver 306, and an X-driver 308. The image processor 300 may convert an external image signal that is received from an external source into an internal image signal. The logic controller 302 may receive the internal image signal and output an address driving control signal SA, a Y driving control signal SY, and an X driving control signal SX. The Y-driver 304, the address driver 306, and the X-driver 308 may receive the driving control signals and output the driving signals to the scan and sustain electrodes Y1 through Yn, address electrodes and sustain electrodes X1 through Xn of the PDP 1, respectively.

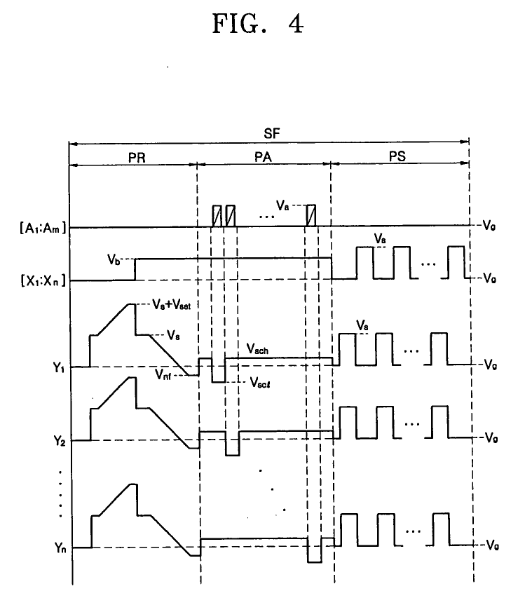

FIG. 4 illustrates an exemplary timing diagram of the driving signals output from the respective drivers of the driving apparatus shown in FIG. 3.

As shown in FIGS. 3 and 4, a unit frame for driving the PDP 1 may be divided into a plurality of subfields. Each subfield SF may be divided into a reset period PR, an address period PA and a sustain period PS.

During the reset period PR, the discharge cells may be reset by performing a reset discharge. The reset discharge may be performed by applying a reset pulse consisting of a rising pulse and a falling pulse to the scan and sustain electrodes Y1 through Yn. When the falling pulse is being applied to the scan and sustain electrodes Y1 through Yn a second voltage Vb may be applied to the sustain electrodes X1 through Xn. All discharge cells may be initialized by the reset discharge. The rising pulse may rise from the first voltage Vs by the third voltage Vset to a maximum voltage Vset+Vs. The falling pulse may fall from the first voltage Vs to a fourth voltage Vnf.

During the address period PA, an address discharge may be performed to select discharge cells that are to undergo a sustain discharge in a following sustain period PS. The address discharge may be performed by sequentially applying a scan pulse to the scan and sustain electrodes Y1 through Yn and applying, in sync with the scan pulse, a display data signal to the address electrodes A1 through Am. The scan pulse may alternate between a fifth voltage Vsch and a sixth voltage Vscl that is lower than the fifth voltage Vsch. The display data signal may have a seventh voltage Va that has a positive polarity and the seventh voltage Va may be applied when the sixth voltage Vscl of the scan pulse is applied.

During the sustain period PS, a sustain discharge may be performed to enable the discharge cells that were selected in the previous address period PA to perform a sustain discharge. A sustain discharge may be performed by alternately applying a sustain pulse to the sustain electrodes X1 through Xn and the scan and sustain electrodes Y1 through Yn. The brightness of a unit field consisting of a plurality of subfields may be represented by performing a sustain discharge according to a gray-level weight assigned to each subfield. The sustain pulse may vary between a first voltage Vs and a ground voltage Vg.

Although the respective drivers shown in FIG. 3 may output the driving signals shown in FIG. 4, however, the driving signals are not limited to those shown in FIG. 4.

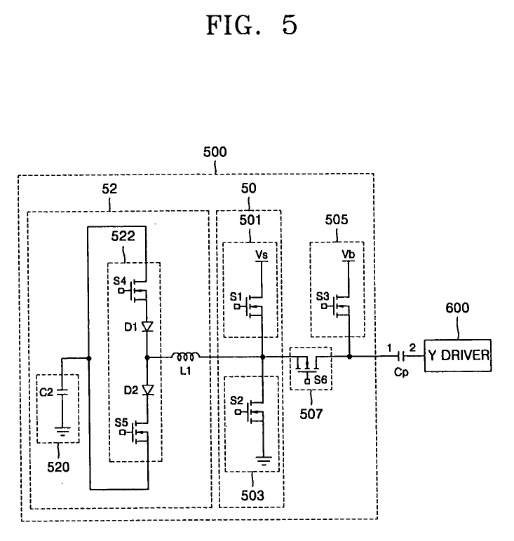

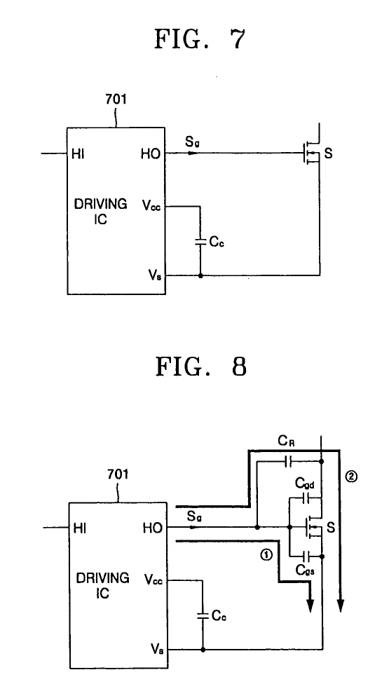

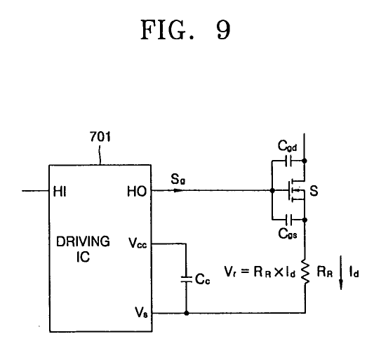

FIG. 5 illustrates a circuit diagram of an exemplary X-driver 500 of a PDP driving apparatus employing one or more aspects of the invention. FIG. 7 illustrates a circuit diagram of a connection scheme for a switching device, a driving IC and a capacitor that may be employed in a PDP driving apparatus employing one or more aspects of the invention. FIG. 8 illustrates a circuit diagram of a connection scheme for a switching device, a driving IC and a capacitor that may be employed by a switching device belonging to a first group of the switching devices in a PDP driving apparatus employing one or more aspects of the invention. FIG. 9 illustrates a circuit diagram of another connection scheme for a switching device, a driving IC and a capacitor that may be employed by a switching device belonging to a first group of switching devices in a PDP driving apparatus employing one or more aspects of the invention.

As shown in FIG. 5, to output a driving signal to the sustain electrodes X1 through Xn (e.g., to a first terminal of a panel capacitor Cp), the PDP driving apparatus may include a sustain pulse applying unit 50 that includes a first voltage applying unit 501 for outputting a first voltage Vs and a ground voltage applying unit 503 for outputting a ground voltage Vg. The PDP driving apparatus may also include a second voltage applying unit 505 for outputting a second voltage Vb, an energy recovery unit 52 for accumulating and storing charges in a PDP, and a switching unit 507.

The first voltage applying unit 501 may include a first switching device S1 having one terminal connected to the first voltage source Vs and another terminal connected to the switching unit 507. The ground voltage applying unit 503 may include a second switching device S2 having one end that is connected to ground and having another terminal that is connected to the switching unit 507. In the sustain pulse applying unit 50 that may include the first voltage applying unit 501 and the ground voltage applying unit 503, the first switching device S1 and the second switching device S2 may be alternately turned on to generate a sustain pulse.

The second voltage applying unit 505 may include a third switching device S3 having one terminal that is connected to the second voltage source Vb and having another terminal that is connected to the sustain electrodes (e.g., the first terminal of the panel capacitor Cp) and the switching unit 507. The third switching device S3 may be turned on so that the second voltage Vb is output to the sustain electrodes of the PDP. The third switching device S3 may be turned on so that the second voltage Vb is output to the sustain electrodes (e.g., the first terminal of the panel capacitor Cp) of the PDP.

The energy recovery unit 52 may include an energy storage unit 520 for storing charges in the panel capacitor Cp, an energy recovery switching unit 522 that is connected to the energy storage unit 520, and an inductor L1 that has one terminal connected to the energy recovery unit 522 and another terminal connected to the sustain electrodes of the PDP. The energy recovery unit 522 may help accumulate the charges stored in the energy storage unit 520 in the panel capacitor Cp and may help store the charges stored in the panel capacitor Cp in the energy storage unit 520. The energy storage unit 520 may include a capacitor C2 for storing charges in the panel capacitor Cp.

The energy recovery switching unit 522 may include a fourth switching device S4, a fifth switching device S5, a first diode D1 and a second diode D2. One terminal of the fourth switching device S4 and one terminal of the fifth switching device S5 may be connected to the energy storage unit 520. Another terminal of the fourth switching device S4 and another terminal of the fifth switching device S5 may be connected to the inductor L1. The first diode D1 and the second diode D2 may be connected between the fourth switching device S4 and the fifth switching device S5.

The operation of the energy recovery unit 52 will be described below. When the fifth switching unit S5 of the energy recovery switching unit 522 is turned on, charges in the panel capacitor Cp may be stored in the second capacitor C2 via the inductor L1, the second diode D2 and the fifth switching device S5. When the fourth switching device S4 is turned on, charges stored in the second capacitor C2 may be accumulated in the panel capacitor Cp via the fourth switching device S4, the first diode D1 and the inductor L1.

The switching unit 507 may include a sixth switching device S6 that has one terminal connected to the sustain pulse applying unit 50 and another terminal connected between the second voltage applying unit 505 and the sustain electrodes (the first terminal of the panel capacitor Cp) of the PDP. The switching unit 507 may perform a switching operation for applying a sustain pulse that is output from the sustain pulse applying unit 50 to the sustain electrodes of the PDP and a switching operation for blocking the second voltage Vb that is output from the second voltage applying unit 505 from the sustain pulse applying unit 50. When the sixth switching device S6 is turned on, a sustain pulse may be applied to the sustain electrodes (e.g., the first terminal of the panel capacitor Cp) of the PDP. When the sixth switching device S6 is turned off, the second voltage Vb may not be applied to the sustain pulse applying unit 50.

FIGS. 7 through 9 illustrate different exemplary connection schemes for connecting a driving IC 701 to each switching device of a PDP driving apparatus employing one or more aspects of the invention. For example, each of the switching devices S1-S6 of the X-driver 500 shown in FIG. 5 may be connected to a driving IC 701 according to one of the connection schemes illustrated in FIGS. 7 through 9.

As shown in FIGS. 7 through 9, the driving IC 701 may output a control signal Sg to the gate terminal of a switching device S in order to drive the switching device S. To quickly switch a switching device S, a capacitor Cc may be connected between a Vcc terminal of the driving IC 701 and the source terminal of the switching device S. When a PDP is initially powered on, an operating voltage Vcc that is applied from an external source may be charged in the capacitor Cc. Charging the operating voltage Vcc in the capacitor Cc that is connected, for example, to each switching device of the X-driver 500 that is shown in FIG. 5 will be described with reference to FIGS. 7 through 9.

When the PDP is initially powered on, an operating voltage Vcc applied from an external source may be charged in the capacitor Cc connected to each switching device. The operating voltage Vcc may be supplied from a power supply (not shown) of the PDP and the range of the voltage Vcc may, in some embodiments, be between about 10V and about 15V.

The switching devices S1 through S6 of the X-driver 500 shown in FIG. 5 may be grouped into a first group of switching devices that have source terminals connected to ground and a second group of the remaining switching devices. In the X-driver 500, the first group may include the second switching device S2 of the ground voltage applying unit 503 and the fifth switching device S5 of the energy recovery switching unit 522. In the X-driver 500, the second group may include the first switching device S1 of the first voltage applying unit 501, the third switching device S3 of the second voltage applying unit 505, the fourth switching device S4 of the energy recovery switching unit 522, and the sixth switching device S6 of the switching unit 507. In the X-driver 500, because the source terminals of the second switching device S2 and the fifth switching device S5, which belong to the first group are connected to ground, the voltage of the source terminals of the second switching device S2 and the fifth switching device S5 is a ground voltage. In the X-driver 500, because a capacitor Cc is connected between the source terminal of each of the switching devices of the first group (e.g., S2 and S5) and the driving IC 701, an operating voltage Vcc that is applied from an external source may be stably charged in the capacitor Cc with respect to the voltage of the source terminals of each of the switching devices of the first group (e.g., S2 and S5).

In the X-driver 500, because the source terminals of the first, third, fourth and sixth switching devices S1, S3, S4, and S6 that belong to the second group are not connected to the ground, unlike the switching devices of the first group (e.g., S2 and S5), the voltages of the source terminals of the switching devices of the second group (e.g., S1, S3, S4 and S6) may not be constant when the connection scheme illustrated in FIG. 7 is employed, for example, with the switching devices of the first group (e.g., S2, S5) to which the source terminals of the second group of switching devices may be connected. Accordingly, when the PDP is initially powered on, an operating voltage Vcc applied from an external source may not be charged in the capacitors Cc that are connected between the source terminals and the Vcc terminals of the driving ICs 701 when the connection scheme illustrated in FIG. 7 is employed with the switching devices of the first group (e.g., S2 and S5) to which the source terminals of the second group of switching devices may be connected.

The switching devices of the second group (e.g., S1, S3, S4 and S6) may be sub-grouped. For example, the switching devices of the second group (e.g., S1, S3, S4 and S6) may be sub-grouped into a 2-1 group of switching devices (e.g., S1, S4, and S6) that have source terminals that are connected to the drain terminal of a switching device belonging to the first group (e.g., S2, S5), and a 2-2 group of any remaining switching device (e.g., S3).

The source terminals of the switching devices of the 2-1 group (e.g., S1, S4 and S6) may be connected to the drain terminal of one of the switching devices of the first group (e.g., S2). To charge an operating voltage Vcc in the capacitor Cc connected to each of the switching devices of the 2-1 group (e.g., S1, S4, and S6), the source terminals of each of the switching devices of the 2-1 group (e.g., S1, S4 and S6) should be grounded. The source terminals of each of the switching devices of the 2-1 group (e.g., S1, S4, and S6) may be grounded by turning on at least one predetermined switching device of the first group (e.g., S2, S5) to which the source terminals of the switching devices of the 2-1 group (e.g., S1, S4, and S6) are connected. In the X-driver 500 shown in FIG. 5, the predetermined switching device may be the second switching device S2 or may be a separate switching device (not shown) that is connected parallel to the second switching device S2. If the second switching device S2 or the separate switching device is turned on, an operating voltage Vcc may be charged in the capacitors Cc that are respectively connected to each of the switching devices of the 2-1 group (e.g., S1, S4 and S6).

However, when the second switching device S2 or the separate switching device is abruptly turned on, a surge current may flow and thus, the switching devices and circuit devices in the driving apparatus may be damaged when the connection scheme illustrated in FIG. 7 is employed with the switching devices of the first group (e.g., S2 and S5). To avoid this problem, the second switching device S2 or the separate switching device should be gradually turned on. Therefore, it may be preferable that the predetermined switching device of first group (e.g., S2 or the separate switching device) that has a drain terminal connected to the source terminals of the switching devices of the 2-1 group (e.g., S1, S4 and S6) output a ramping signal.

In the embodiment of a connecting scheme shown in FIG. 8, a ramping capacitor C_{R} is added between the drain terminal and the gate terminal of a switching device S. As discussed above, in the X-driver 500 shown in FIG. 5, the predetermined switching device of first group (e.g., S2 or the separate switching device) that has a drain terminal connected to the source terminals of the switching devices of the 2-1 group (e.g., S1, S4 and S6) may be connected using the connecting scheme illustrated in FIG. 8 so that the predetermined switching device of the first group may output a ramping signal to the switching devices of the 2-1 group (e.g., S1, S4 and S6). In embodiments, the predetermined switching device of the first group (e.g., S2 or the separate switching device) may be connected using the connection scheme shown in relation to the switching device S shown in FIG. 8. To turn on a switching device S that is connected to a driving IC in accordance with the connecting scheme shown in FIG. 8, first, a parasitic capacitor Cgs that exists between the gate terminal and the source terminal of the switching device S may be charged and then a parasitic capacitor Cgd that exists between the gate terminal and the drain terminal of the switching device S may be charged. By adding a ramping capacitor C_{R} to the parasitic capacitor Cgd to charge the capacitor Cgs, it is possible to lengthen a time period from when a current begins to flow through a switching device S at a voltage higher than a threshold voltage to when the current completely flows through the switching device S. More particularly, as shown in FIG. 8, the capacitor Cgs may be charged through path \textcircled{1}, the switching device S is slightly turned on, and a gate current may flow through path \textcircled{2}, so that the capacitor Cgs is discharged and the switching device S closes. At this time, the paths \textcircled{1} and \textcircled{2} may provide a negative feedback effect to each other and the switching device S may operate as a constant-current source.

In the other embodiment of a connecting scheme shown in FIG. 9, which may be used to output a ramping signal from a switching device S, a ramping resistor R_{R} may be connected to the source terminal of the switching device S. In embodiments, the predetermined switching device of the first group (e.g., S2 or the separate switching device) may be connected using the connection scheme shown in relation to the switching device S shown in FIG. 9. As described above in relation to the switching device S shown in FIG. 8, a gate current charges the capacitor Cgs, so that the switching device S is turned on and a current Id flows. The current Id abruptly rises while charging the capacitor Cgd and the voltage charged in the capacitor Cgs falls by a drop of a voltage Vr that is applied on a resistor R2. Due to the falling of the voltage that is charged in the capacitance Cgs, the switching device S again closes and the current Id is reduced. While the current Id is reduced, the voltage drop Vr is reduced and the voltage of the capacitor Cgs rises, so that the switching device S again opens.

As discussed above, in embodiments of a PDP driving apparatus, the second group may include the 2-1 group of switching devices (e.g., S1, S3, S4 and S6) that have a source terminal connected to a drain terminal of a predetermined switching device of the first group of switching devices and the 2-2 group of switching devices (e.g., S3). To charge the operating voltage Vcc in the capacitor Cc connected between the source terminals of the switching devices of the 2-2 group (e.g., S3), and the Vcc terminal of the respective driving ICs 701, a predetermined switching device of the first group and a predetermined switching device of the 2-1 group should be turned on.

As discussed above, in the X-driver 500, the predetermined switching device of the first group may be the second switching device S2 or the separate switching device. In the X-driver 500, the predetermined switching device of the 2-1 group may be the sixth switching device S6. That is, to charge the capacitor Cc associated with the switching devices of the 2-2-group (e.g., S3), at least one one of the second switching device S2 and the separate switching device should be turned on in addition to the predetermined switching device of the 2-1 group (e.g., S6). Similar to the switching devices of the 2-1 group (e.g., S1, S4 and S6), which may rely on the predetermined switching device of the first group (e.g., S2 or the separate switching device) to be turned on gradually, when the operating voltage Vcc is charged in the capacitors Cc that are respectively connected to the switching devices of the 2-1 group (e.g., S1, S4, and S6), at least the predetermined switching device of the first group (e.g., S2 or the separate switching device) should be gradually turned on in addition to the sixth switching device S6 to enable a ramping signal to be output from those switching devices. In some embodiments, to output a ramping signal, as shown in FIG. 8, a ramping capacitor C_{R} may be connected between the gate terminal and drain terminal of the switching device S. In some embodiments, as shown in FIG. 9, a ramping resistor R_{R} may be connected to the source terminal of the switching device S.

In such a manner, the operating voltage Vcc can be stably charged in the capacitors Cc that are respectively connected to each of the switching devices (e.g., S1 through S6) of the X-driver 500 shown in FIG. 5.

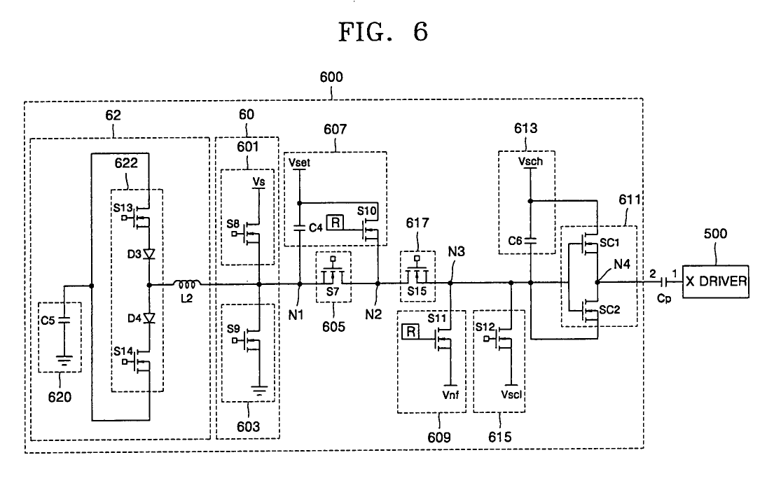

FIG. 6 is a circuit diagram of an exemplary Y-driver 600 of a PDP driving apparatus employing one or more aspects of the invention.

Operation of the Y-driver 600 of a PDP driving apparatus employing one or more aspects of the invention will be described with reference to FIGS. 4 and 6 through 9. To output a driving signal to the scan and sustain electrodes (e.g., a second terminal of the capacitor Cp), a PDP driving apparatus according to the invention may include a sustain pulse applying unit 60, a first switching unit 605, a second switching unit 617, a third voltage applying unit 607, a fourth voltage applying unit 609, a scan switching unit 611, a fifth voltage applying unit 613, a sixth voltage applying unit 615 and an energy recovery unit 62.

The sustain pulse applying unit 60 may include a first voltage applying unit 601 for outputting a first voltage Vs to a first node N1 and a ground voltage applying unit 603 for outputting a ground voltage Vg to the first node N1. The first switching unit 605 may include a seventh switching device S7 having one terminal that is connected to the first node N1 and having another terminal that is connected to a second node N2. The second switching unit 617 may include a fifteenth switching device S15 having one terminal that is connected to the second node N2 and another terminal that is connected to a third node N3. The third voltage applying unit 607 may be connected between the first node N1 and the second node N2 to gradually increase the first voltage Vs by the third voltage Vset and to output the increased voltage to the second node N2. The fourth voltage applying unit 609 may be connected to the third node N3 to gradually decrease the first voltage Vs to a fourth voltage Vnf and to output the decreased voltage to the third node N3. The scan switching unit 611 may include a first scan switching device SC1 and a second scan switching device SC2, which are connected in series to each other and a fourth node N4 between the first scan switching device SC1 and the second scan switching device SC2 may be connected to the scan and sustain electrodes (e.g., the second terminal of the capacitor Cp) of the PDP. The fifth voltage applying unit 613 may include the fifth voltage source Vsch and may be connected to the first scan switching device SC1 to output a fifth voltage Vsch to the first scan switching device SC1. The sixth voltage applying unit 615 may be connected to the third node N3 and the second scan switching device SC2 to output a sixth voltage Vscl. The energy recovery unit 62 may help accumulate charges in the capacitor Cp and may help store the charges stored in the capacitor Cp.

The first voltage applying unit 601 may include an eighth switching device S8 having one terminal that is connected to the first voltage source Vs and having another terminal that is connected to the first node N1. The ground voltage applying unit 603 may include a ninth switching device S9 having one terminal that is connected to a ground and another terminal that is connected to the first node N1. In the sustain pulse applying unit 60, which may include the first voltage applying unit 601 and the ground voltage applying unit 603, the eighth switching device S8 and the ninth switching device S9 may be alternately turned on to generate a sustain pulse.

The third voltage applying unit 607 may include a fourth capacitor C4 and a tenth switching device S10. The fourth capacitor C4 may have one terminal that is connected to the first node N1 and another terminal that is connected to the third voltage source Vset. The tenth switching device S10 may be connected between the third voltage source Vset and the second node N2. When the seventh switching device S7 of the first switching unit 605 is turned off, the fifteenth switching device S15 of the second switching unit 617 may turn on and the eighth switching device S8 of the first voltage applying unit 601 and the tenth switching device S10 of the third voltage applying unit 617 may also turned on, so that the first voltage Vs may rise by the third voltage Vset to a maximum voltage Vset+Vs and the maximum voltage Vset+Vs may be output to the third node N3.

The fourth voltage applying unit 609 may include a twelfth switching device S11 having one terminal that is connected to the third node N3 and another other terminal that is connected to the fourth voltage source Vnf. To output a voltage that is gradually falling form the first voltage Vs to the fourth voltage Vnf to the third node N3, the eighth switching device S8 of the first voltage applying unit 601, the seventh switching device S7 of the first switching unit 605, the fifteenth switching device S15 of the second switching unit 617, and the eleventh switching device S11 of the fourth voltage applying unit 609 may be turned on.

The sixth voltage applying unit 615 may include the twelfth switching device S12 that may be connected between the third node N3 and the sixth voltage source Vscl. The twelfth switching device S12 may be turned on so that a sixth voltage Vscl may be output to the third node N2. When the first scan switching device SC1 of the scan switching unit 611 is turned on and the second scan switching device SC2 is turned off, the fifth voltage Vsch may be output to the scan and sustain electrodes (e.g., the second terminal of the capacitor Cp) via the fourth node N4.

When the first scan switching device SC1 of the scan switching unit 611 is turned off and the second scan switching device SC2 is turned on, the respective voltages output to the third node N3, that is, for example, the first voltage Vs, the ground voltage Vg, the maximum rising voltage Vs+Vset, the fourth voltage Vnf, and the sixth voltage Vscl may be output to the scan and sustain electrodes (e.g., the second terminal of the capacitor Cp) via the fourth node N4.

The energy recovery unit 62 may include an energy storage unit 620 for storing charges in the capacitor Cp, an energy recovery switching unit 622, and an inductor L2. The energy recovery switching unit 622 may be connected to the energy storage unit 620 to help accumulate charges stored in the energy storage unit 620 in the capacitor Cp or to help store the charges stored in the capacitor Cp in the energy storage unit 620. The inductor L2 may have one terminal that is connected to the energy recovery switching unit 622 and another other terminal that is connected to the first node N1. The energy storage unit 620 may include a capacitor C5 for storing the charges in the capacitor Cp.

The energy recovery switching unit 622 may include a thirteenth switching device S13 and a fourteenth switching device S14 that each have one terminal connected to the energy storage unit 620 and another terminal connected to the inductor L2. A third diode D3 and a fourth diode D4 may be connected between the thirteenth switching device S13 and the fourteenth switching device S14.

In the following description of an operation of the energy recovery unit 62, it is assumed that the seventh switching device S7 of the first switching unit 605 and the second scan switching unit SC2 of the scan switching unit 611 are turned on. When the fourteenth switching device S14 of the energy recovery switching unit 622 is turned on, the charges in the capacitor Cp may be stored in the fifth capacitor C5 via the inductor L2, the fourth diode D4, and the fourteenth switching device S14. When the thirteenth switching device S13 of the energy recovery switching unit 622 is turned on, the charges stored in the fifth capacitor C5 may be accumulated in the capacitor Cp via the thirteen switching device S13, the third diode D3, and the inductor L2.

Each of the switching devices S7-S15 shown in FIG. 6 may be connected to the driving IC 701 using one of the connecting schemes shown in FIGS. 7, 8, and 9. As discussed above, the driving IC 701 outputs a control signal Sg to the gate terminal of the switching device S, so to drive the respective switching device S. To quickly switch the switching device S, the capacitor Cc may be connected between the Vcc terminal of the driving IC 701 and the source terminal of the switching device S. When the PDP is initially powered on, an operating voltage Vcc supplied from an external source is charged in the capacitor Cc

Charging the operating voltage Vcc in the capacitor Cc connected to each of the switching devices S7-S15 shown in FIG. 6 will be described with reference to FIGS. 7, 8, and 9 below.

The plurality of switching devices S7-S15 shown in FIG. 6 may be grouped into a first group of switching devices that have source terminals connected to a voltage source that outputs a voltage that is lower than a ground voltage and a second group of switching devices not belonging to the first group.

Referring to driving signals shown in FIG. 4, in the Y-driver 600, because the fourth voltage source Vnf and the sixth voltage source Vscl may output a voltage lower than the ground voltage Vg, the first group may include the ninth switching device S9 of the ground voltage applying unit 603, the eleventh switching device S11 of the fourth voltage applying unit 609, the twelfth switching device S12 of the sixth voltage applying unit 615, and the fourteenth switching device S14 of the energy recovery switching unit 622. In the Y-driver 600, the second group of switching devices may include the eighth switching device S8 of the first voltage applying unit 601, the seventh switching device S7 of the first switching unit 605, the fifteenth switching device S15 of the second switching unit 617, the tenth switching device S10 of the third voltage applying unit 617, the first and second scan switching devices SC1 and SC2 of the scan switching unit 611, and the thirteenth switching device S13 of the energy recovery switching unit 622.

When the PDP is initially powered on, an operating voltage Vcc that is applied from an external source may be charged in the capacitor Cc connected to each of the switching devices of a PDP driving apparatus that, in embodiments, may include the Y-driver 600 shown in FIG. 6. The operating voltage Vcc may be applied from a power supply of the PDP and in embodiments, the range of the operating voltage Vcc may be between about 10V and about 15V.

In the Y-driver 600, when the source terminals of the switching devices of the first group S9, S11, S12, and S14 are connected to ground or a voltage source outputting a voltage that is lower than a ground voltage, the voltage of the source terminals is ground voltage or the voltage that is lower than ground voltage. Because the capacitor Cc may be connected between the source terminal of each of the switching devices of the first group S9, S11, S12, and S14 and the Vcc terminal of the respective driving ICs 701, an operating voltage Vcc applied from an external source can be stably charged in the capacitor Cc.

In the Y-driver 600, when the source terminals of the switching devices of the second group S7, S8, S10, S15, SC1, and SC2 are not connected to ground or a voltage source outputting a voltage lower than the ground voltage, unlike the switching devices of the first group S9, S11, S12, and S14, the voltages of the source terminals of the switching devices S7, S8, S10, S15, SC1, and SC2 that do not have source terminals connected to ground or a voltage source less than ground are not constant. Accordingly, when the PDP is initially powered on, an operating voltage Vcc that is applied from an external source is not charged in the capacitors Cc that are connected between the source terminals and the Vcc terminals of the respective driving ICs 701.

The switching devices of the second group (e.g., S7, S8, S10, S13, S15, SC1, and SC2) may be sub-grouped into a 2-1 group of switching devices (e.g. S7, S8, S13, S15, and SC2) having source terminals connected to the drain terminal of one of the switching devices belonging to the first group, and a 2-2 group of switching devices (e.g., SC10 and SC1) having source terminals connected to the drain terminals of the switching devices belonging to the 2-1 group. In the Y-driver 600, the switching devices of the 2-1 group may include the eighth switching device S8 of the first voltage applying unit 601, the seventh switching device S7 of the first switching unit 605, the fifteenth switching device S15 of the second switching unit 617, the second scan switching device SC2 of the scan switching unit 611, and the thirteenth switching device S13 of the energy recovery switching unit 622. In the Y-driver 600, the switching devices of the 2-2 group may include the tenth switching device S10 of the third voltage applying unit 607, and the first scan switching unit SC1 of the scan switching unit 611.

Each of the source terminals of the switching devices of the 2-1 group (e.g., S7, S8, S10, S13, S15, SC1, and SC2) may be connected to the drain terminal of a predetermined one of the switching devices of the first group of switching devices. In the Y-driver 600, the predetermined switching device of the first group may be the ninth switching device S9, the eleventh switching device S11, the twelfth switching device S12, the fourteenth switching device S14, or the separate switching device (not shown) that is connected parallel to the ninth switching device S9. To charge an operating voltage Vcc in a charge capacitor Cc connected to each of the switching devices of the 2-1 group (e.g., S7, S8, S10, S13, S15, SC1, and SC2) the voltages of the source terminals of the switching devices of the 2-1 group (e.g., S7, S8, S10, S13, SC1, and SC2) should be lower than ground voltage. The operating voltage Vcc may be charged in the charge capacitor Cc of the switching devices of the 2-1 group when at least one of the switching devices of the first group (e.g., S9, S11, S12, S14) and/or the separate switching device is turned on. For example, in the Y-driver 600, when the ninth switching device S9 or the separate switching device is turned on, an operating voltage Vcc may be charged in the capacitors Cc that are respectively connected to the seventh switching device S7, the eighth switching device S8, and the thirteenth switching device S13. In the Y-driver 600, for example, when the eleventh switching device S11 is turned on, an operating voltage Vcc may be charged in the capacitors Cc that are respectively connected to each of the fifteenth switching device S11 and the second scan switching device SC2. In the Y-driver 600 shown in FIG. 6, when the twelfth switching device S12 is turned on, an operating voltage Vcc may be charged in the capacitors Cc that are respectively connected to the fifteenth switching device S15 and the second scan switching device SC2.

However, if the switching devices S9, S11, S12, S14 and/or the separate switching device is/are abruptly turned on, a surge current can flow and accordingly, circuit devices that include switching devices can be damaged. To avoid this problem, the predetermined switching device(s) of the first group (e.g., S9, S11, S12, S14) and/or the separate switching device should be gradually turned on. Therefore, it is preferable to output a ramping signal from the switching devices belonging to the first group (e.g., S9, S11, S12, S14) and/or the separate switching device.

As discussed above, FIG. 8 illustrates an exemplary embodiment of a connecting scheme that employs a ramping capacitor C_{R}. In embodiments, the ramping capacitor C_{R} may be added between the drain terminal and gate terminal of each of the switching devices of the first group S9, S11, S12, S14 and if provided, the separate switching device (not shown). In embodiments, each of the switching devices of the first group S9, S11, S12, S14 and the separate switching device may be connected using the connection scheme shown in relation to the switching device S shown in FIG. 8.

The other connecting scheme, which is shown in FIG. 9, may be used in embodiments for the predetermined switching devices of the first group (e.g., S9, S11, S12, S14, the separate switching device) to respectively output a ramping signal therefrom. As discussed above, in the connecting scheme of FIG. 9, to output a ramping pulse from the switching device S, a ramping resistor R may be connected to the source terminal of each of the switching devices of the first group (e.g., S9, S11, S12, S14, and the separate switching device).

As discussed above, in embodiments, the second group of switching devices may include the 2-1 group of switching devices (e.g., S7, S8, S13, S15 and SC2) that have a source terminal connected to a drain terminal of a predetermined switching device of the first group (e.g., S9, S11, S12, S14 and the separate switching device), and the 2-2 group of switching devices (e.g., S10, SC1). In embodiments, to charge an operating voltage Vcc in the capacitor Cc connected between the source terminal of each of the switching devices of the 2-2 group (e.g., SC1 and SC10) and the Vcc terminal of the respective driving ICs 701, all of the switching devices of the first group and all of the switching devices having a source terminal connected to a drain terminal of one of the switching devices of the first group should be turned on.

For example, in the Y-driver 600, to charge an operating voltage in a capacitor Cc that is connected to the tenth switching device S10, the ninth switching device S9 or the separate switching device, which is one of the switching devices of the first group, should be turned on in addition to the seventh switching device S7, which is connected to the ninth switching device S9 or the separate switching device. When such conditions are met, the voltage of the source terminal of the tenth switching device S10 becomes a ground voltage. In the Y-driver 600, to charge an operating voltage Vcc in the capacitor Cc connected to the first scan switching device SC1, the eleventh switching device S11 or the twelfth switching device S12, which is one of the switching devices of the first group, should be turned on in addition to the second scan switching device SC2 connected to the eleventh switching device S11 or the twelfth switching device S12. When such conditions are met, the voltage of the source terminal of the first scan switching device SC1 becomes lower than the ground voltage.

Similar to the switching devices of the 2-1 group (e.g., S7, S8, S13, S15, SC2), which may rely on the predetermined switching device(s) of the first group (e.g., S9, S11, S12, S14) to be turned on gradually, when the operating voltage Vcc is charged in the capacitors Cc connected to each of the switching devices of the 2-1 group (e.g., S7, S8, S13, S15 and SC2), the predetermined switching device(s) of the first group and the 2-1 group must be gradually turned on to enable a ramping signal to be respectively output therefrom. In some embodiments, to output a ramping signal, as shown in FIG. 8, a ramping capacitor C_{R} may be connected between the gate terminal and the drain terminal of the switching device S. In some embodiments, as shown in FIG. 9, a ramping resistor R_{R} may be connected to the source terminal of the switching device S.

By employing, for example, one of the connecting schemes shown in FIGS. 8 and 9 with the switching devices of the first group of switching devices and the applicable predetermined switching device(s) of the 2-1 group of switching devices, an operating voltage Vcc may be stably charged in the capacitor Cc connected to each of all the switching devices S7 through S15 of the Y-driver 600 shown in FIG. 6.

As described above, exemplary embodiments of the invention can obtain at least the following advantages.

Embodiments of a PDP driving apparatus of the invention make it is possible to stably charge an operating voltage in a capacitor that is connected to each of switching devices of the driving apparatus when the PDP is initially powered on.

In embodiments of a PDP driving apparatus of the invention, when an operating voltage is charged to a capacitor that is connected to a switching device having a source terminal that is not connected to a voltage source outputting a voltage that is lower than ground voltage, by gradually turning on a switching device connected to a voltage source that is outputting a voltage lower than ground voltage, it is possible to reduce and preferably prevent switching devices and other circuit devices from being damaged due to a surge current caused by an abrupt turning-on operation.

Exemplary embodiments of the invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as set forth by the following claims.

What is claimed is:

1. A driving apparatus of a plasma display panel (PDP), comprising:
a plurality of voltage sources;
a plurality of switching devices including a first group of switching devices and a second group of switching devices; and
a plurality of driving circuits, each controlling a switching operation of a respective one of the plurality of switching devices to output a driving signal from the respective one of the plurality of switching devices,
wherein:
a capacitor is respectively connected between each of the plurality of driving circuits and a source terminal of the respective one of the plurality of switching devices,
each driving circuit receives an operating voltage Vcc from an external source and outputs a control signal to a gate terminal of the respective one of the plurality of switching devices, wherein:
the first group of switching devices includes the switching devices of the plurality of switching devices that have a source terminal connected to one of the plurality of voltage sources that outputs one of a ground voltage and a voltage less than ground voltage,
the second group includes remaining ones of the plurality of switching devices
when the PDP is initially powered on, the operating voltage Vcc is directly charged in the capacitors that are respectively connected to the plurality of switching devices of the first group, and when a predetermined switching device of the switching devices belonging to the first group is gradually turned on, the operating voltage Vcc is charged in the capacitors respectively connected to respective ones of the switching devices of the second group.

2. The driving apparatus as claimed in claim 1, wherein the predetermined switching device outputs a ramping signal when turned on.

3. The driving apparatus as claimed in claim 2, wherein a ramping capacitor is connected between a gate terminal and a drain terminal of the predetermined switching device.

4. The driving apparatus as claimed in claim 2, wherein a ramping resistor is connected to a source terminal of the predetermined switching device.

5. The driving apparatus as claimed in claim 1, wherein the second group includes a switching device of the plurality of switching devices that has a source terminal that is connected to a drain terminal of the predetermined switching device.

6. The driving apparatus as claimed in claim 1, wherein the source terminals of the switching devices of the second group are connected to a drain terminal of the predetermined switching device of the plurality of switching devices, and
each of the switching devices that are connected to the predetermined switching device is turned on and the operating voltage Vcc is charged in the capacitors that are respectively connected to each of the switching devices of the second group.

7. A driving apparatus of a plasma display panel (PDP), comprising:
a plurality of voltage sources;
a plurality of driving circuits, the plurality of driving circuits receiving an operating voltage from an external source;
a plurality of switching devices including a first group of switching devices and a second group of switching devices;
a capacitor connected to each of the plurality of switching devices, one terminal of each capacitor being connected to a source terminal of the respective switching device; and
at least one of a ramping capacitor and a ramping resistor connected to the switching devices of the first group to output a ramping signal from the switching devices of the first group,
wherein the first group of switching devices includes the switching devices of the plurality of switching devices that have a source terminal that is directly connected to one of the plurality of voltage sources that outputs one of a ground voltage and a voltage less than ground voltage, and the second group including any remaining ones of the plurality of switching devices.

8. The driving apparatus according to claim 7, wherein the driving apparatus includes a plurality of ramping resistors, each connected to a respective one of the switching devices of the first group.

9. The driving apparatus of claim 8, wherein the ramping resistor has a terminal connected to the source terminal of the respective one of the plurality of switching devices of the first group, and another terminal connected to a terminal of the respective capacitor.

10. The driving apparatus according to claim 7, wherein the driving apparatus includes a plurality of ramping capacitors, each connected to a respective one of the switching devices of the first group.

11. The driving apparatus according to claim 10, wherein the ramping capacitor has a first terminal connected to a drain of the respective switching device of the first group and a second terminal connected to a gate of the respective switching device of the first group.

12. The driving apparatus according to claim 7, wherein:
the second group of switching devices includes a first sub-group and a second sub-group, the first sub-group including at least of the switching devices of the plurality of switching devices that has a source terminal connected to a drain terminal of at least one of the switching devices of the first group, and the second sub-group including any remaining ones of the plurality of switching devices, and
at least one of a ramping capacitor and a ramping resistor is connected to the switching devices of the first sub-group to output a ramping signal from the switching devices of the first sub-group.

13. The driving apparatus according to claim 12, wherein the driving apparatus includes a plurality of ramping resistors, each connected to a respective one of the switching devices of the first sub-group.

14. The driving apparatus of claim 13, wherein the ramping resistor has a terminal connected to the source terminal of the respective one of the plurality of switching devices of the first sub-group, and another terminal connected to a terminal of the respective capacitor.

15. The driving apparatus according to claim 12, wherein the driving apparatus includes a plurality of ramping capacitors, each connected to a respective one of the switching devices of the first sub-group.

16. The driving apparatus according to claim 15, wherein the ramping capacitor has a first terminal connected to a drain of the respective switching device of the first group and a second terminal connected to a gate of the respective switching device of the first sub-group.

17. The driving apparatus according to claim 12, wherein the first sub-group includes switching devices of the plurality of switching devices that has a source terminal connected to a drain terminal of at least one of the switching devices of the first group and a drain terminal connected to a source terminal of at least one of the switching devices of the second sub-group.

18. The driving apparatus according to claim 17, wherein each of the switching devices of the second sub-group has a source terminal that is connected to at least one of the switching devices of the first sub-group.

19. A driving apparatus of a plasma display panel (PDP), comprising:
a plurality of voltage sources;
a plurality of driving circuits, the plurality of driving circuits receiving an operating voltage from an external source;
a plurality of switching devices including a first group of switching devices and a second group of switching devices;
a capacitor connected to each of the plurality of switching devices, one terminal of each capacitor being connected to a source terminal of the respective switching device; and
ramping signal producing means for outputting a ramping signal from the switching devices of the first group,
wherein the first group of switching devices includes the switching devices of the plurality of switching devices that have a source terminal that is directly connected to one of the plurality of voltage sources that outputs one of a ground voltage and a voltage less than ground voltage, and the second group of switching devices includes any remaining one of the plurality of switching devices.

20. The driving apparatus according to claim 19, wherein the second group of switching devices includes a first sub-group and a second sub-group, the first sub-group including at least of the switching devices of the plurality of switching devices that has a source terminal connected to a drain terminal of at least one of the switching devices of the first group, and the second sub-group including any remaining ones of the plurality of switching devices,
wherein ramping signal producing means are provided for the first sub-group for outputting a ramping signal from the switching devices of the first sub-group.
